(19) United States
(12) Patent Application Publication
(10) Pub. No.: US 2025/0298895 A1
(43) Pub. Date: Sep. 25, 2025

(54) LOGGING AND REMEDIATION LOGIC IN MEMORY

(71) Applicant: Micron Technology, Inc., Boise, ID (US)

(72) Inventors: Jeremy Chritz, Seattle, WA (US); David Hulton, Seattle, WA (US); Tamara Schmitz, Scotts Valley, CA (US); Max S. Vohra, Boise, ID (US)

(73) Assignee: Micron Technology, Inc., Boise, ID (US)

(21) Appl. No.: 19/061,807

(22) Filed: Feb. 24, 2025

Related U.S. Application Data
(60) Provisional application No. 63/569,335, filed on Mar. 25, 2024.

(51) Int. Cl. G06F 21/55; G06F 21/54

(52) U.S. Cl. CPC G06F 21/554; G06F 21/54; G06F 21/552

(57) ABSTRACT

A system includes a memory comprising a memory cell array configured to store data and a logging logic circuit configured to generate a log of detected faults or attacks on the memory cell array, and a host hosting a hypervisor. The hypervisor is configured to host a virtual machine, including managing data allocation for processes of the virtual machine to a first region of the memory cell array. The hypervisor is further configured to receive the log of detected faults or attacks? generated by the logging logic circuit. In response to a determination that the first region of the memory cell array has a detected fault or attack based on the log of detected faults or attacks, re-direct data allocation for the virtual machine to a second region of the memory cell array.

### CROSS REFERENCE TO RELATED APPLICATION(S)

This application claims the benefit under 35 U.S.C. § 119 of the earlier filing date of U.S. Provisional Application Ser. No. 63/569,335 filed Mar. 25, 2024, the entire contents of which is hereby incorporated by reference in its entirety for any purpose.

### BACKGROUND

Many traditional computer systems have different security protocols and algorithms used to set security protocols to access data. In multi-tenant, virtualized computing applications, preventing access to restricted data stored in shared memory can be challenging. For example, a hacker may attempt to access a particular region of memory or a particular memory device. Typically, the solution may be to take offline/shutdown a data center server, including memory devices, until a security breach is resolved. For example, a hypervisor may prevent access to the whole memory device until the security breach is resolved. This is because, while hypervisors may provide a level of security for virtual machines, they may not have information specific to an individual memory, obtained from the memory itself, much less specific memory regions. Taking down an entire server may be a costly and inefficient use of data center resources.

### BRIEF DESCRIPTION OF THE DRAWINGS

FIG. 1 is a block diagram showing a computing system 100, according to an example described herein.

FIG. 2 is a schematic block diagram of a semiconductor device 200, according to examples described herein.

FIG. 3 is flowchart of a method 300 for operating a computer system, according to examples described herein.

### DETAILED DESCRIPTION OF PREFERRED EMBODIMENTS

Certain details are set forth below to provide a sufficient understanding of embodiments of the invention. However, it will be clear to one skilled in the art that embodiments of the invention may be practiced without various of these particular details. In some instances, well-known wireless communication components, circuits, control signals, timing protocols, computing system components, and software operations have not been shown in detail in order to avoid unnecessarily obscuring the described embodiments of the invention. With improvements in programming capabilities and the continually increasing demand for persistent and low-power memory devices, there is a need for a computer system with the ability to determine and apply different security protocols (e.g., encryption techniques) for handling different types of data.

This disclosure describes examples of remediation logic and logging logic integrated into a memory to facilitate isolation of compromised memory regions via a hypervisor until a security issue is addressed. That is, the remediation logic and logging logic may facilitate aspects of security for cloud computing environments and/or data center applications that utilize a virtualized architecture including a hypervisor hosting virtual machines. In doing so and advantageously, the remediation logic and logging logic may provide additional security against hackers and/or remediate memory faults occurring at individual memories.

In certain embodiments where a memory controller is connected to the host via a peripheral component interconnect express (PCIe) bus or similar bus including packetized delays, the latency of the PCIe bus may prevent malicious actors from repeatedly accessing memories, e.g., that are being used by certain virtual machines. In an example, the remediation logic, responsive to receiving logs of particular faults (e.g., an ECC fault, wrong encryption key used, etc.) occurring at a row or region of memory, may determine that a particular region of memory is to be quarantined from further memory access requests or attempts. Because additional memory access requests would include the latency of the PCIe bus, the remediation logic, located at the memory itself, may adeptly, in real-time, isolate or quarantine regions of memory where the fault occurred; thereby preventing further memory access attempts from a malicious actor.

In addition, while making data allocation decisions, hypervisors may use data provided by memories, to determine whether data is allocated to certain memory regions, banks, or even individual rows of a respective memory. For example, the logging logic of the memory devices may provide information (e.g., logged information) to a hypervisor to make allocation and reallocation decisions for their respective memory regions (e.g., to not allocate data to certain regions until a security breach or event (e.g., row-hammer attack or similar event)) is resolved.

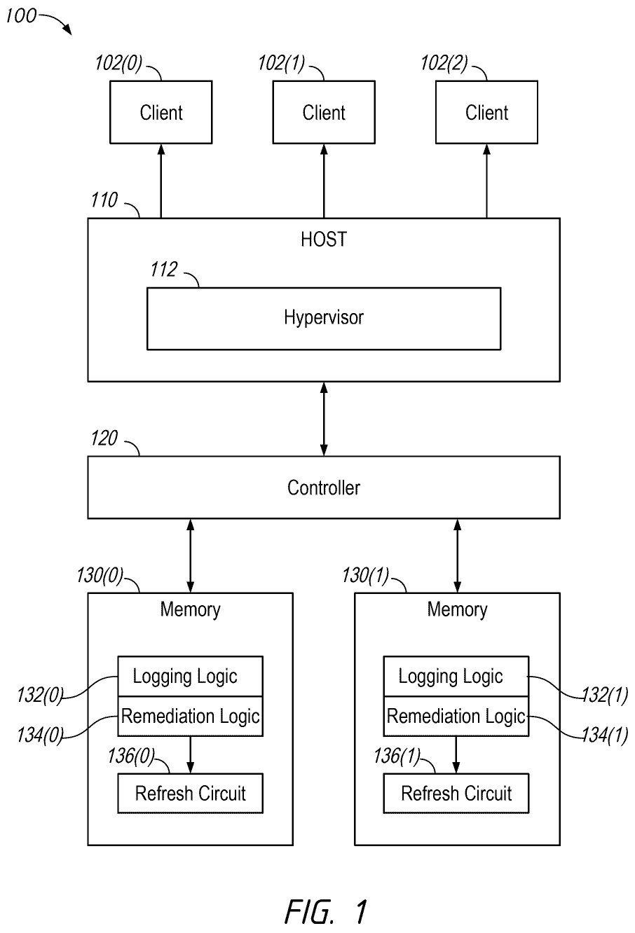

FIG. 1 is a block diagram showing a computing system 100, according to an example described herein. The computer system 100 may include a host computing device 110 coupled to memories 130(0)-(1) via a controller 120. The host computing device 110 may be configured to host a hypervisor 112, which may manage virtual machines 102(0)-(2). While FIG. 1 depicts three of the virtual machines 102(0)-(2), it is appreciated that the host computing device 110 may be capable of hosting any number of clients without departing from the scope of the disclosure.

The virtual machines 102(0)-(2) may include virtual machines or VMs. A VM generally refers to a specific software-based implementation of a machine in a virtualization environment, in which the hardware resources of a computer (e.g., CPU, memory, etc.) are abstracted from direct access via the hypervisor 112, which is a layer of software hosted directly on the host computing device 110. The hypervisor 112 may manage data allocation for processes of the virtual machines 102(0)-(2) using a connected controller 120 (e.g., a compute express link (CXL) controller connected via PCIe bus to the host computing device 110) and the memories 130(0)-(1) coupled thereto. While FIG. 1 depicts two of the memories 130(0)-(1), it is appreciated that the computing system 100 may be capable of hosting any number of memories without departing from the scope of the disclosure. The hypervisor 112 may be configured to allocate hardware resources dynamically and transparently. This virtualization may allow multiple of the virtual machines 102(0)-(2) to run concurrently on a single physical computer (e.g., the host computing device 110) and share hardware resources (e.g., a processor of the host computing device 110 and the memories 130(0)-(1) with each other. That is, the hypervisor 112 may facilitate physical storage to and retrieval of data from the memories 130(0)-(1) for each of the virtual machines 102(0)-(2) in a way that abstracts each of the virtual machines 102(0)-(2) from having visibility to the actual storage architecture.

Each of the memories 130(0)-(1) may include a respective logging logic circuit 132(0)-(1) and a respective remediation logic circuit 134(0)-(1). Each of the logging logic circuits 132(0)-(1) may detect and count certain actions occurring at an individual memory 130(0)-(1), such as bit flips, row-hammer attacks, or ECC faults. For example, the logging logic circuits 132(0)-(1) may log the number of times one of those actions occurs at a particular row of the memory array or a particular logical or physical region of the respective memory array.

The logs may be provided to the hypervisor 112 for data allocation decisions. For example, the hypervisor 112 may detect patterns (e.g., if a “honeybucket” is planted in a particular memory 130(0)-(1) or memory region of a memory 130(0)-(1)) and/or identify regions of memory that are frequently faulted. In turn, the hypervisor 112 may determine that certain data (e.g., critical data or the like) is to be allocated to regions of memory that do not have frequent faults.

The logs may also be provided to the respective remediation logic circuit 134(0)-(1) to determine an action or response to the logs at the memory 130(0)-(1) itself. For example, the remediation logic circuits 134(0)-(1) may determine that a logged fault occurring repetitively at a particular row of a respective memory array of the memory 130(0)-(1) is a “row-hammer” attack, and thus may send a signal to a respective refresh circuit 136(0)-(1) that the row is to be refreshed or reset. The remediation logic circuits 134(0)-(1) may also implement responses to regions of the memory array based on a decision of the hypervisor 112, e.g., that a particular region of the memory array be quarantined or inaccessible to certain of the virtual machines 102(0)-(2).

More generally, the controller 120 and/or the hypervisor 112 may also receive the logs and/or communicate with the remediation logic circuit 134(0)-(1) at each memory 130(0)-(1) to determine actions to take with respect to data allocation at the respective memories 130(0)-(1). Accordingly, memories 130(0)-(1) themselves may provide information to the hypervisor 112, which is used by the hypervisor 112 to make data allocation decisions responsive to receiving that information. Advantageously, the computing system 100 with the logging logic circuit 132(0)-(1) and the remediation logic circuit 134(0)-(1) may facilitate a secure computing environment for hosted virtual machines 102(0)-(2) because malicious actors may not access portions of memories 130(0)-(1) that are detected as having faults; while still providing for efficient access to the memories 130(0)-(1), e.g., as requested by applications hosted on the virtual machines 102(0)-(2).

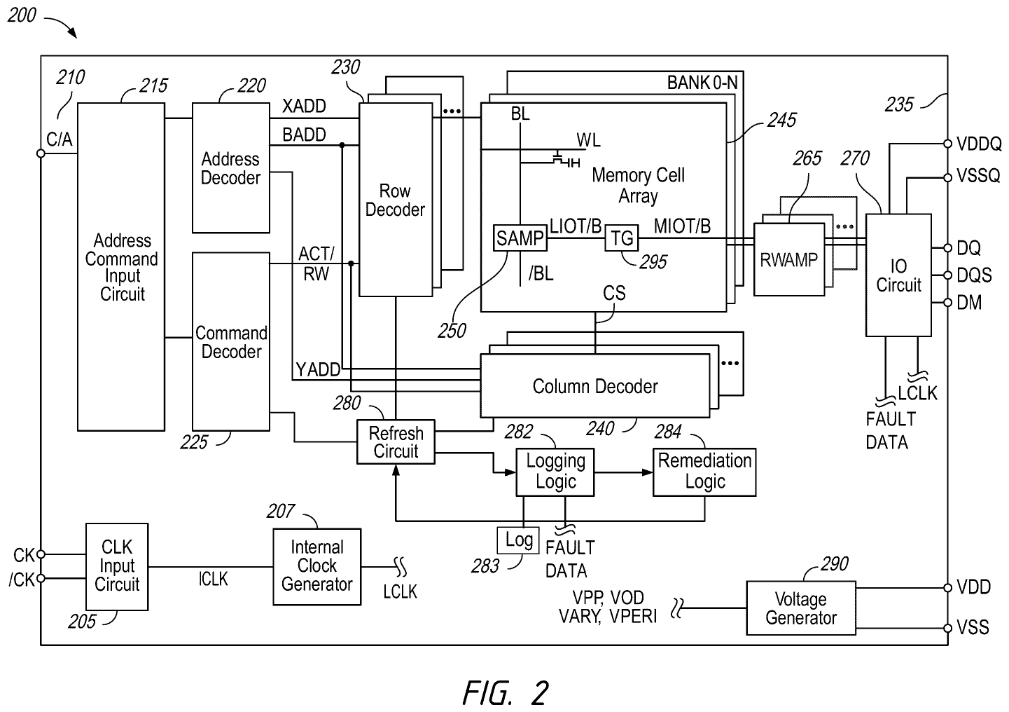

FIG. 2 is a schematic block diagram of a semiconductor device 200, according to examples described herein. For example, the semiconductor device 200 may include a chip 235. Any of the memories 130(0)-(1) of FIG. 1 may implement the semiconductor device 200, in some examples. The chip 235 may include a clock input circuit 205, an internal clock generator 207, an address command input circuit 215, an address decoder 220, a command decoder 225, a plurality of row decoders 230, a memory cell array 245 including sense amplifiers 250 and transfer gates 295, a plurality of column decoders 240, a plurality of read/write amplifiers 265, an input/output (I/O) circuit 270, and a voltage generator 290. The semiconductor device 200 may include a plurality of external terminals including address and command terminals coupled to command/address bus 210, clock terminals CK and/CK, data terminals DQ, DQS, and DM, and power supply terminals VDD, VSS, VDDQ, and VSSQ. The chip 235 may be mounted on a substrate, for example, a memory module substrate, a mother board or the like.

The memory cell array 245 includes a plurality of banks BANKO-N, each bank BANKO-N including a plurality of word lines WL, a plurality of bit lines BL, and a plurality of memory cells MC arranged at intersections of the plurality of word lines WL and the plurality of bit lines BL. The number of banks BANKO-N may include 2, 4, 8, 16, or any other number of banks. Each of the banks BANKO-N may be divided into two or more memory planes (e.g., column planes), which may be selected by the column select CS signal from the column decoders 240. In some examples, each of the banks BANKO-N may include 2, 4, 8, 16, 32, etc., column planes. The selection of the word line WL for each bank is performed by a corresponding row decoder 230 and the selection of the bit line BL is performed by a corresponding column decoder 240. The plurality of sense amplifiers 250 are located for their corresponding bit lines BL and coupled to at least one respective local I/O line further coupled to a respective one of at least two main I/O line pairs, via transfer gates TG 295, which function as switches. In some examples, the sense amplifiers 250 may include column select (CS) and local input/output (LIO) circuits and the transfer gates TG 295 may include corresponding read circuits. The address/command input circuit 215 may receive an address signal and a bank address signal from outside at the command/address terminals via the command/address bus 210 and transmit the address signal and the bank address signal to the address decoder 220. The address decoder 220 may decode the address signal received from the address/command input circuit 215 and provide a row address signal XADD to the row decoder 230, and a column address signal YADD to the column decoder 240. The address decoder 220 may also receive the bank address signal and provide the bank address signal BADD to the row decoder 230 and the column decoder 240.

The address/command input circuit 215 may receive a command signal from outside, such as, for example, a memory controller 205 at the command/address terminals via the command/address bus 210 and provide the command signal to the command decoder 225. The command decoder 225 may decode the command signal and generate various internal command signals. For example, the internal command signals may include a row command signal to select a word line, a column command signal, such as a read command or a write command, to select a bit line.

When a read command is issued and a row address and a column address are timely supplied with the activation and read commands (ACT/RW), read data is read from a memory cell in the memory cell array 245 designated by the row address and the column address. The read/write amplifiers 265 may receive the read data DQ and provide the read data DQ to the IO circuit 270. The IO circuit 270 may provide the read data DQ to outside via the data terminals DQ, together with a data strobe signal at DQS and/or a data mask signal at DM. Similarly, when the write command is issued and a row address and a column address are timely supplied with the ACT and write commands R/W, and then the input/output circuit 270 may receive write data at the data terminals DQ, together with a data strobe signal at DQS and/or a data mask signal at DM and provide the write data via the read/write amplifiers 265 to the memory cell array 245. Thus, the write data may be written in the memory cell designated by the row address and the column address. In some examples, the input/output circuit 270 may include an error correction code (ECC) circuit configured to generate ECCs for incoming write data and to decode ECCs in read data in an effort to mitigate storage errors at the memory cell array 145.

Turning to the explanation of the external terminals included in the semiconductor device 200, the clock terminals CK and/CK may receive an external clock signal and a complementary external clock signal, respectively. The external clock signals (including complementary external clock signal) may be supplied to a clock input circuit 205. The clock input circuit 205 may receive the external clock signals and generate an internal clock signal ICLK. The clock input circuit 205 may provide the internal clock signal ICLK to an internal clock generator 207. The internal clock generator 207 may generate a phase controlled internal clock signal LCLK based on the received internal clock signal ICLK and a clock enable signal CKE from the address/command input circuit 215. Although not limited thereto, a DLL circuit may be used as the internal clock generator 207. The internal clock generator 207 may provide the phase controlled internal clock signal LCLK to the IO circuit 270. The IO circuit 270 may use the phase controller internal clock signal LCLK as a timing signal for determining an output timing of read data.

The power supply terminals may receive power supply voltages VDD and VSS. These power supply voltages VDD and VSS may be supplied to a voltage generator circuit 290. The voltage generator circuit 290 may generate various internal voltages, VPP, VOD, VARY, VPERI, and the like based on the power supply voltages VDD and VSS. The internal voltage VPP is mainly used in the row decoder 230, the internal voltages VOD and VARY are mainly used in the sense amplifiers 250 included in the memory cell array 245, and the internal voltage VPERI is used in many other circuit blocks. The power supply terminals may also receive power supply voltages VDDQ and VSSQ. The IO circuit 270 may receive the power supply voltages VDDQ and VSSQ. For example, the power supply voltages VDDQ and VSSQ may be the same voltages as the power supply voltages VDD and VSS, respectively. However, the dedicated power supply voltages VDDQ and VSSQ may be used for the IO circuit 270.

In some examples, the semiconductor device 200 may further include a refresh circuit 280, a logging logic circuit 282, and a remediation logic circuit 284. The refresh circuit 280 may manage refresh operations of the memory cell array 245 based on commands from the command decoder 225 by providing refresh row XADD and column YADD addresses to the row decoder 230 and the column decoder 240. The logging logic circuit 282 may detect and count certain actions occurring at the memory cell array 245, such as wrong encryption key used, bit flips, row-hammer attacks, or ECC faults based on data from the refresh circuit 280 and the input/output circuit 270, and log those detected actions in log 283. The log 283 may be stored at the memory cell array 245 or at another register or auxiliary storage location. For example, the logging logic circuit 282 may log in the log 283 the number of times one of those actions occurs at a particular row of the memory cell array 245 or a particular logical or physical region of the memory cell array 245.

The logs 283 may also be provided to the remediation logic circuit 284 to determine an action or response to the logs 283. For example, the remediation logic circuit 284 may determine that a logged fault occurring repetitively at a particular row of a respective memory cell array 245 is a “row-hammer” attack, and thus may send a signal to refresh circuit 280 that the row is to be refreshed or reset.

In a virtualized computing application, the logs may be provided to a hypervisor (not shown) for data allocation decisions. The hypervisor may detect patterns (e.g., if a “honeybucket” is planted in the memory cell array 245 or memory region of the memory cell array 245 and/or identify regions of the memory cell array 245 that are frequently faulted. In turn, the hypervisor may determine that certain data (e.g., critical data or the like) is to be allocated to regions of memory cell array 245 that do not have frequent faults.

The remediation logic circuit 284 may also implement responses to regions of the memory cell array 245 based on a decision of the hypervisor, e.g., that a particular region of the memory cell array 245 be quarantined or inaccessible to certain of applications (e.g., virtual machines or clients).

More generally, a memory controller (not shown) or a hypervisor may receive the logs and/or communicate with the remediation logic circuit 284 to determine actions to take with respect to data allocation at the memory cell array 245. Accordingly, the semiconductor device 100 themselves may provide information to the hypervisor, which is used by the hypervisor to make data allocation decisions responsive to receiving that information. Advantageously, the semiconductor device with the logging logic circuit 282 and the remediation logic circuit 284 may facilitate a secure computing environment for because malicious actors may not access portions of the memory cell array 245 that are detected as having faults, while still providing for efficient access to the memory cell array 245.

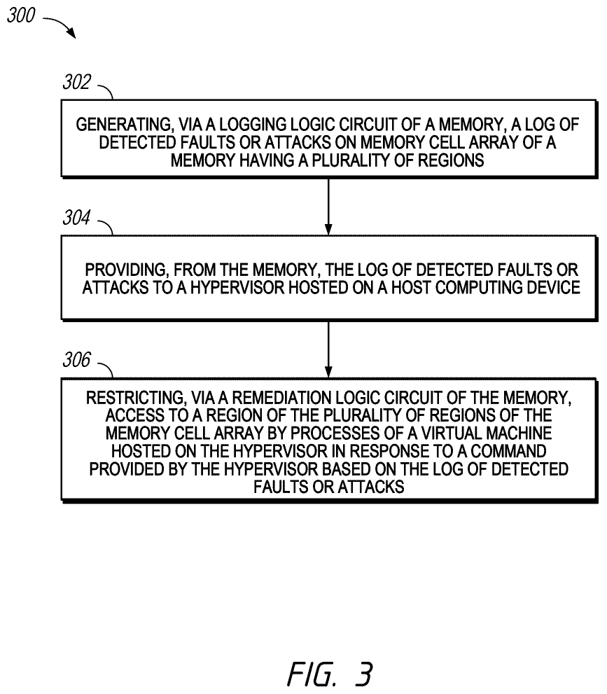

FIG. 3 is flowchart of a method 300 for operating a computer system, according to examples described herein. The method 300 may be performed by the computing system 100 of FIG. 1 and/or the semiconductor device 200 of FIG. 2.

The method 300 may include generating, via a logging logic circuit of a memory, a log of detected faults or attacks on a memory cell array of a memory having a plurality of regions, at 302. The logging logic circuit may include the logging logic circuits 132(0)-(1) of FIG. 1 and/or the logging logic circuit 282 of FIG. 2. The memory may include either of the memories 130(0)-(1) of FIG. 1 and/or the semiconductor device 200 of FIG. 2. The memory cell array may include the memory cell array 245 of FIG. 2. The method 300 may include providing, from the memory, the log of detected faults or attacks to a hypervisor hosted on a host computing device, at 304. The hypervisor and the host computing device may include the hypervisor 112 and the host computing device 110, respectively, of FIG. 1. In some examples, the method 300 may further include generating, via the logging logic circuit, an entry in the log of detected faults or attacks based on an ECC fault, detection that a wrong encryption key was used, a bit flip, or any combination thereof. The entry may be maintained in a log stored at the memory (e.g., the log 283 of FIG. 2).

The method 300 may include restricting, via a remediation logic circuit of the memory, access to a region of the plurality of regions of the memory cell array by processes of a virtual machine hosted on the hypervisor in response to a command provided by the hypervisor based on the log of detected faults or attacks, at 306. The remediation logic circuit may include the remediation logic circuits 134(0)-(1) of FIG. 1 and/or the remediation logic circuit 284 of FIG. 2. The virtual machine may include any of the virtual machines 102(0)-(2) of FIG. 1. In some examples, the method 300 may further include causing, via the remediation logic circuit, data stored in the region of the plurality of regions of the memory cell array for the processes of the virtual machine to be moved to another region of the plurality of regions of the memory cell array in response to the command provided by the hypervisor based on the log of detected faults or attacks. In some examples, the method 300 may further include receiving the command from the host via a controller. In some examples, the command is provided to the controller via a peripheral component interconnect express bus.

In some examples, the method 300 may further include in response to a determination that a row of the memory cell array has a detected row hammer attack based on the log of detected faults or attacks from the logging logic circuit, causing, via the remediation logic circuit, a refresh of the row of the memory cell array.

The various illustrative blocks and modules described in connection with the disclosure herein may be implemented or performed with a general-purpose processor, a DSP, an application-specific integrated circuit (ASIC), an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that may be accessed by a general purpose or special purpose computer. By way of example, and not limitation, non-transitory computer-readable media may comprise RAM, ROM, electrically erasable programmable read only memory (EEPROM), or optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above are also included within the scope of computer-readable media.

Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

From the foregoing it will be appreciated that, although specific examples have been described herein for purposes of illustration, various modifications may be made while remaining within the scope of the claimed technology. The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

Although the embodiments of the present invention have been described with reference to the disclosed embodiments, persons skilled in the art will recognize that changes may be made in form and detail without departing from the embodiments of the invention.

What is claimed is:

1. A system comprising:
a memory comprising a memory cell array configured to store data and a logging logic circuit configured to generate a log of detected faults or attacks on the memory cell array; and
a host hosting a hypervisor, wherein the hypervisor is configured to host a virtual machine, including managing data allocation for processes of the virtual machine to a first region of the memory cell array, wherein the hypervisor is configured to receive the log of detected faults or attacks? generated by the logging logic circuit, wherein, in response to a determination that the first region of the memory cell array has a detected fault or attack based on the log of detected faults or attacks, re-direct data allocation for the virtual machine to a second region of the memory cell array.

2. The system of claim 1, wherein the memory includes a remediation logic circuit configured to, in response to a determination that a row of the memory cell array has a detected row hammer attack based on the log of detected faults or attacks from the logging logic circuit, cause a refresh of the row of the memory cell array.

3. The system of claim 2, wherein the remediation logic circuit is further configured to restrict access to the first region by processes of the virtual machine based on information provided to the memory by the hypervisor.

4. The system of claim 1, further comprising a controller coupled between the host and the memory, wherein the controller is configured to facilitate communication between the hypervisor and the memory for the data allocation for the processes of the virtual machine.

5. The system of claim 4, wherein the controller is coupled to the host via a peripheral component interconnect express bus.

6. The system of claim 1, wherein the hypervisor is configured to determine a third region of the memory cell array has a fewest number of logged faults based on the log of detected faults or attacks and to direct data allocation for a second virtual machine to the third region of the memory cell array.

7. The system of claim 1, wherein the logging logic circuit is configured to generate an entry in the log of detected faults or attacks based on an ECC fault, detection that a wrong encryption key was used, a bit flip, or any combination thereof.

8. An apparatus comprising:
a connection to hypervisor hosted on a host computing device;
a memory cell array comprising a plurality of regions configured to store data;
a logging logic circuit configured to generate a log of detected faults or attacks on the memory cell array and to provide the log of detected faults or attacks to the hypervisor via the connection; and
a remediation logic circuit configured to restrict access to a region of the plurality of regions of the memory cell array by processes of a virtual machine hosted on the hypervisor in response to a command provided by the hypervisor based on the log of detected faults or attacks.

9. The apparatus of claim 8, wherein, in response to a determination that a row of the memory cell array has a detected row hammer attack based on the log of detected faults or attacks from the logging logic circuit, the remediation logic circuit is configured to cause a refresh of the row of the memory cell array.

10. The apparatus of claim 9, further comprising a refresh circuit configured to perform the refresh of the row of the memory cell array based on a refresh command from the remediation logic.

11. The apparatus of claim 8, wherein the remediation logic circuit is configured cause data stored in the region of the plurality of regions of the memory cell array for the processes of the virtual machine to be moved to another region of the plurality of regions of the memory cell array in response to the command provided by the hypervisor based on the log of detected faults or attacks.

12. The apparatus of claim 8, wherein the memory is coupled directly to a controller to receive the command from the hypervisor.

13. The apparatus of claim 12, wherein the controller is coupled to the host via a peripheral component interconnect express bus.

14. The system of claim 8, wherein the logging logic circuit configured to generate an entry in the log of detected faults or attacks based on an ECC fault, detection that a wrong encryption key was used, a bit flip, or any combination thereof.

15. A method comprising:
generating, via a logging logic circuit of a memory, a log of detected faults or attacks on memory cell array of a memory having a plurality of regions;
providing, from the memory, the log of detected faults or attacks to a hypervisor; and
restricting, via a remediation logic circuit of the memory, access to a region of the plurality of regions of the memory cell array by processes of a virtual machine hosted on the hypervisor in response to a command provided by the hypervisor based on the log of detected faults or attacks.

16. The method of claim 15, further comprising, in response to a determination that a row of the memory cell array has a detected row hammer attack based on the log of detected faults or attacks from the logging logic circuit, causing, via the remediation logic circuit, a refresh of the row of the memory cell array.

17. The method of claim 15, further comprising causing, via the remediation logic circuit, data stored in the region of the plurality of regions of the memory cell array for the processes of the virtual machine to be moved to another region of the plurality of regions of the memory cell array in response to the command provided by the hypervisor based on the log of detected faults or attacks.

18. The method of claim 15, further comprising receiving the command from the hypervisor via a controller.

19. The method of claim 18, wherein the command is provided to the controller via a peripheral component interconnect express bus.

20. The method of claim 15, further comprising generating, via the logging logic circuit, an entry in the log of detected faults or attacks based on an ECC fault, detection that a wrong encryption key was used, a bit flip, or any combination thereof.
